(19) United States
(12) Patent Application Publication
(10) Pub. No.: US 2013/0083756 A1
(43) Pub. Date: Apr. 4, 2013

(54) E-DCH Resource Control

(71) Applicants: Jose Luis Pradas, Stockholm (SE); Henrik Enbuske, Stockholm (SE); Paulson Angelo Vijay Silveris, Spanga (SE)

(72) Inventors: Jose Luis Pradas, Stockholm (SE); Henrik Enbuske, Stockholm (SE); Paulson Angelo Vijay Silveris, Spanga (SE)

(73) Assignee: TELEFONAKTIEBOLAGET LM ERICSSON (PUBL), Stockholm (SE)

(21) Appl. No.: 13/641,156

(22) PCT Filed: Sep. 3, 2012
(86) PCT No.: PCT/SE2012/050932

§ 371 Date: Oct. 15, 2012

Related U.S. Application Data
(60) Provisional application No. 61/541,194, filed on Sep. 30, 2011.

(51) Int. Cl. H04W 72/00

(52) U.S. Cl. CPC H04W 72/00
USPC 370/329

(57) ABSTRACT

Mechanisms are described that are useful if source and target radio configuration for a UE used in the RRC message uses E-DCH. Thus, when a UE having a common E-DCH resource receives a pre-defined message, the message in particular being an RRC Radio Bearer (RB) Reconfiguration message or an RRC RB Setup message or an RRC Connection setup, moving the UE to CELL_DCH state with E-DCH configured in the target state, the UE is configured to hold on to the common E-DCH resource.

TECHNICAL FIELD

The present invention relates to methods and devices for handling E-DCH resources in a cellular radio system.

### BACKGROUND

3rd Generation Partnership Project (3GPP) standardized in Release 8 “Enhanced Uplink in CELL_FACH and Idle mode”. This feature enables a User Equipment (UE) of a cellular radio network to transmit data on an Enhanced Dedicated Channel (E-DCH) channel while in Idle Mode or in CELL_FACH state in Connected Mode, see also 3GPP Technical Specification TS 25.319 v8.11.0 which is the Stage 2 specification and gives an overview of features.

A UE requests access to the network using a random signature. In Release 8, there are two set of signatures: one set to request access using Random Access Channel (RACH), another set of signatures to request access using E-DCH.

If the network broadcasts the parameters to use “Enhanced Uplink in CELL_FACH state and Idle mode”, and the UE supports this feature, then the UE randomly selects a signature from a pool of signatures dedicated to request access using E-DCH.

The network grants access through the Acquisition Indicator Channel (AICH). Once the UE is granted access, the UE can start the transmission of its data. When the UE has emptied its buffer, the UE releases the common E-DCH resources.

There are different mechanisms defined in 3GPP to release common E-DCH resources depending on whether the UE is in Idle mode or in CELL_FACH state in Connected Mode.

In Idle Mode, the UE transmits the Scheduling Information (SI) when it empties its buffer. The transmission of Scheduling Information shall only be triggered when Total E-DCH Buffer Status (TEBS) becomes zero and the Medium Access Control-i (MAC-i) Protocol Data Unit (PDU) containing the last data is being transmitted. The SI is transmitted with the MAC-i PDU carrying the last data, given the serving grant is sufficient to carry the SI with the last remaining data. Otherwise, the empty buffer status report is transmitted separately with the next MAC-i PDU. The UE releases the common E-DCH resources after that a SI with TEBS equal to zero has been sent and no MAC-i PDUs are left for (re-)transmission in MAC.

In addition, the UE shall release the common E-DCH resources if the maximum E-DCH resource allocation for Common Control Channel (CCCH) has been reached. This parameter is configured by the network.

For CELL_FACH, the release of the common E-DCH resources is done explicitly and, if configured, implicitly.

The explicit release is initiated by the network. The network sends the E-DCH Absolute Grant Channel (E-AGCH) with grant value equal to INACTIVE. When the UE receives this message, the UE releases the common E-DCH resources.

The implicit release is configured when the Information Element IE E-DCH transmission continuation back off is not set to infinity. A timer Tb is set to E-DCH transmission continuation back off value (a value other than zero value), when TEBS is 0 byte and the last generated MAC-i PDU with higher layer data is provided. If TEBS becomes different than 0 byte while timer Tb is running, then the timer is stopped and uplink data transmission on the common E-DCH resource continues. If a MAC-ehs PDU is received while timer Tb is running, then the timer is re-started.

If the E-DCH transmission continuation back off value is set to 0, then the SI shall be transmitted with the MAC-i PDU carrying the last Dedicated Control Channel/Dedicated Traffic Channel DCCH/DTCH data, given the serving grant is sufficient to carry the SI in the same MAC-i PDU together with the remaining data. Otherwise, the empty buffer status report is transmitted separately with the next MAC-i PDU. If the timer Tb expires, the empty buffer status report is transmitted separately with the next MAC-i PDU.

The UE releases the common E-DCH resources after SI with TEBS equal to zero has been sent and no MAC-i PDUs are left for (re-)transmission in MAC.

There is a constant desire to improve performance of cellular radio systems. Hence there is a need for an improved performance in a cellular radio system using an E-DCH channel.

### SUMMARY

It is an object of the present invention to provide an improved methods and devices to address the problems as outlined above.

This object and others are obtained by methods and devices as set out in the appended claims.

As has been realized by the inventors, when implicit release of common E-DCH resource is enabled, the UE sends the SI with TEBS equal to zero to implicitly indicate that the common E-DCH resources will be eventually released.

Once the SI is sent, the UE releases the common E-DCH resources when no MAC-i PDU is left in a HARQ process for (re-)transmission.

Upon the reception of a Radio Resource Control (RRC) message like, for example, RRC Radio Bearer Setup or RRC Radio Bearer Reconfiguration message by the UE in Idle mode, or in CELL_FACH state in Connected Mode, the UE has a maximum time defined in 3GPP technical specification TS 25.331 v8.15.0 “Radio Resource Control (RRC); Protocol specification” to apply the configuration given in the RRC message.

| Procedure title: | UTRAN −> UE | UE −> UTRAN | N1 | N2 | Notes |
|---|---|---|---|---|---|
| Radio bearer reconfiguration | RADIO BEARER | RADIO BEARER | 10 | 11 | This requirement applies when |
| From Idle Mode and state | RECONFIGURATION | RECONFIGURATION | | | the UE has a common E-DCH |
| CELL_FACH to state | | COMPLETE/ | | | resource and is not required to |
| CELL_DCH | | FAILURE | | | perform any synchronization. |
| Radio bearer establishment | RADIO BEARER | RADIO BEARER | 10 | NA | N2 cannot be specified, |
| Target state CELL_DCH | SETUP | SETUP COMPLETE/ | | | because the RADIO BEARER |
| | | FAILURE | | | SETUP COMPLETE/ |
| | | | | | FAILURE message is |
| | | | | | transmitted only after physical |
| | | | | | layer synchronisation, which |
| | | | | | depends also on Node B. |

N1 is the upper limit on the time required to execute modifications in UE after the reception of a “UTRAN -> UE” message has been completed. Where applicable (e.g. the physical layer transmission is impacted), the changes shall be adopted in the beginning of the next TTI starting after N1. N1 is specified as a multiple of 10 ms.

The RRC Radio Bearer Reconfiguration/RRC Radio Bearer Setup may change the UE RRC state to CELL_DCH state from CELL_FACH state in Connected Mode, or from Idle mode. Currently, if the UE has a common E-DCH resource in CELL_FACH state in Connected Mode, or a common E-DCH resource in Idle mode.

The UE has to apply the new configuration received in RRC Radio Bearer Reconfiguration and RRC Radio Bearer Setup in less than N1. This is illustrated in FIG. 10. It is not defined in the standard what the UE does during that time. However, this can be specified in a standard for example in 3GPP TS 25.331 v8.15.0.

As it may be implementation specific, some UEs may continue the data transmissions in the common E-DCH resource for some time, or the Tb timer may expire. This can result in that the UE empties its buffer and initiate the implicit release i.e. to send the SI to implicitly indicate the release of the common E-DCH resources. Once all HARQ processes have been acknowledged and no more HARQ processes are pending for re-transmission, the UE will release the common E-DCH resources.

When the UE applies the configuration given in the RRC message, the UE needs to perform a synchronization procedure A as defined in TS 25.214 v8.11.0, because the common E-DCH resource was already released. The synchronization procedure A will introduce several hundreds of milliseconds delay and it will impact the end-user performance, which is not desired.

However, if the UE can be made to hold on to the common E-DCH resource when it moves to CELL_DCH state, the UE does not need to perform synchronization procedure A, which would provide an advantage compared to existing mechanisms.

Even though, no implicit release exists in Idle mode, the mechanism is the same. If the UE after receiving RRC connection setup message can be made to hold on to the common E-DCH resources to avoid the synchronization procedure A when it moves to CELL_DCH state this would be advantageous.

The mechanisms described above are useful if source and target radio configuration for a UE used in the RRC message uses E-DCH. Thus, when a UE having a common E-DCH resource receives a pre-defined message, the message in particular being an RRC Radio Bearer (RB) Reconfiguration message or an RRC RB Setup message or an RRC Connection setup, moving the UE to CELL_DCH state with E-DCH configured in the target state, the UE is configured to hold on to the common E-DCH resource.

Thus, exemplary mechanisms to avoid releasing the common E-DCH resource when the UE has received an RRC Radio Bearer (RB) Reconfiguration message or RRC RB Setup message or RRC Connection setup, which will move the UE to CELL_DCH state with E-DCH configured in the target state are provided. When one or more of these events occur the UE is configured to not release the E-DCH resource. The UE can be in idle mode or the UE can be in CELL_FACH state.

In accordance with some embodiments a method in a User Equipment, UE, is provided where the UE has a common Enhanced Dedicated Channel, E-DCH, resource. The UE receives a pre-defined message moving the UE from a source state to a target state where the target state is a CELL_DCH state with E-DCH configured. Upon reception of said pre-defined message, the UE is configured to hold on to the common E-DCH resource.

In accordance with some embodiment the pre-defined message is an RRC Radio Bearer (RB) Reconfiguration message.

In accordance with some embodiments the pre-defined message is an RRC RB Setup message.

In accordance with some embodiments the pre-defined message is an RRC Connection setup.

In accordance with some embodiments, the UE when receiving the pre-defined message is in idle mode.

In accordance with some embodiments, the UE when receiving the pre-defined message is in CELL_FACH state in connected mode.

The invention also extends to a User Equipment (UE) arranged to perform the methods as described above. The UE can be provided with a controller/controller circuitry for performing the above methods. The controller(s) can be implemented using suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor or may include, without limitation, digital signal processor (DSP) hardware, ASIC hardware, read only memory (ROM), random access memory (RAM), and/or other storage media.

### BRIEF DESCRIPTION OF THE DRAWINGS

The present invention will now be described in more detail by way of non-limiting examples and with reference to the accompanying drawing, in which:

FIG. 1a is a view of a cellular radio system,

FIG. 1b is a flow cart illustrating different steps performed in a UE having a common E-DCH resource,

FIGS. 2-4 are flow chart depicting different steps performed when controlling a UE in idle mode having a common E-DCH resource,

FIGS. 5-9 are flow chart depicting different steps performed when controlling a UE in CELL_FACH state having a common E-DCH resource, and

FIG. 10 is an illustration of a new configuration.

### DETAILED DESCRIPTION

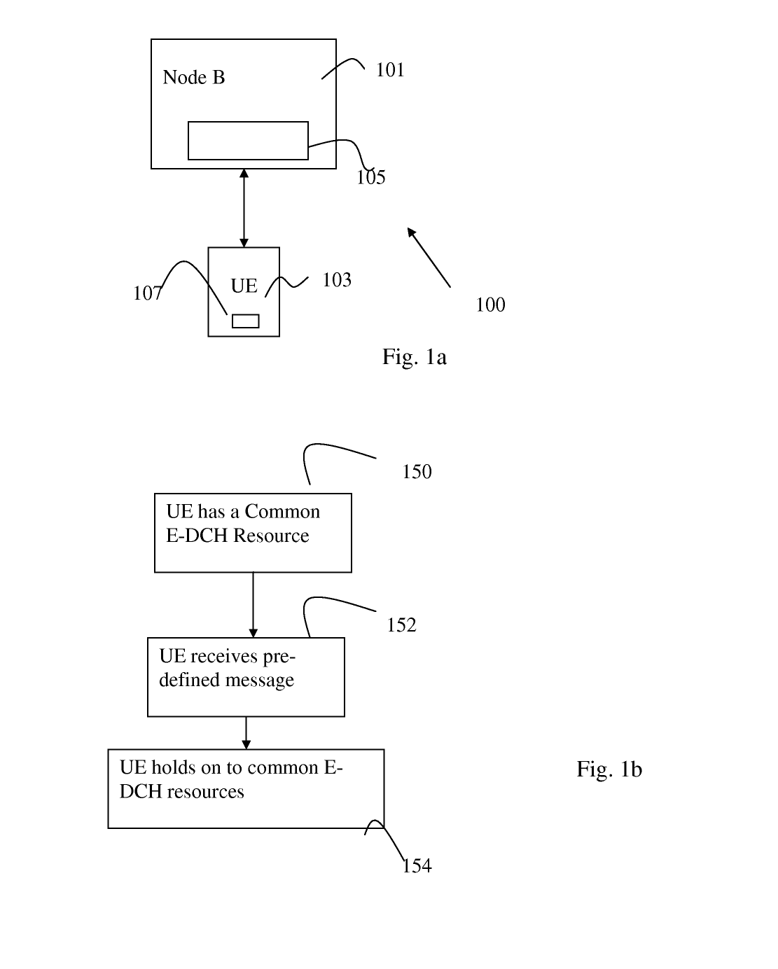

In FIG. 1a a general view of a cellular radio system 100 is depicted. The system 100 depicted in FIG. 1 is a UTRAN system. However it is also envisaged that the system can be another similar system. The system 100 comprises a number of base stations 101, whereof only one is shown for reasons of simplicity. The base station 101 can be connected to by user equipments in the figure represented by the UE 103 located in the area served by the base station 101. Further, the base stations 101 are controlled by a central node such as a Radio Network Controller (RNC) in the case of an UTRAN system. The base station and the user equipment further comprise controllers/controller circuitry 105, 107 and for providing functionality associated with the respective entities. The controllers 105, 107 and can for example comprise suitable hardware and or software. The hardware can comprise one or many processors that can be arranged to execute software stored in a readable storage media. The processor(s) can be implemented by a single dedicated processor, by a single shared processor, or by a plurality of individual processors, some of which may be shared or distributed. Moreover, a processor may include, without limitation, digital signal processor (DSP) hardware, ASIC hardware, read only memory (ROM), random access memory (RAM), and/or other storage media.

In particular the UE can be configured to perform the methods described below using dedicated controller circuitry as exemplified above.

In the system above the UE can be configured to control E-DCH resources in an improved manner. Thus, in accordance with some embodiments, when a UE having a common E-DCH resource receives a message, such as a an RRC Radio Bearer (RB) Reconfiguration message or an RRC RB Setup message or an RRC Connection setup, moving the UE to a target state, such as a CELL_DCH state with E-DCH configured in the target state, the UE is configured to hold on to the common E-DCH resource. The E-DCH resource can be held onto during transition to the target state.

This is illustrated in FIG. 1b. In FIG. 1b a method performed in a User Equipment (UE) is illustrated. First, in a step 150, the UE is configured with a common Enhanced Dedicated Channel (E-DCH) resource. Then, in a step 152, the UE receives a pre-defined message, said message moving the UE from a source state to a target state where the target state is a CELL_DCH state with E-DCH configured. Upon reception of said pre-defined message, the UE is in a step 154 configured to hold on to the common E-DCH resource.

In some embodiments the UE is initially in idle mode or in CELL_FACH state when being moved to a target state with E-DCH configured in the target state. Below some exemplary methods whereby the UE can hold on to the E-DCH resource when being moved to a target state with E-DCH configured in the target state are described. The exemplary methods are first described when the UE is in Idle mode and then when the UE is in CELL_FACH state.

In Idle Mode:

The embodiments below can be used one by one or in some cases in combination.

When the RRC connection setup message is received by the UE and if the UE is allocated a common E-DCH resource, then the UE is configured to not send the SI with TEBS equal to zero.

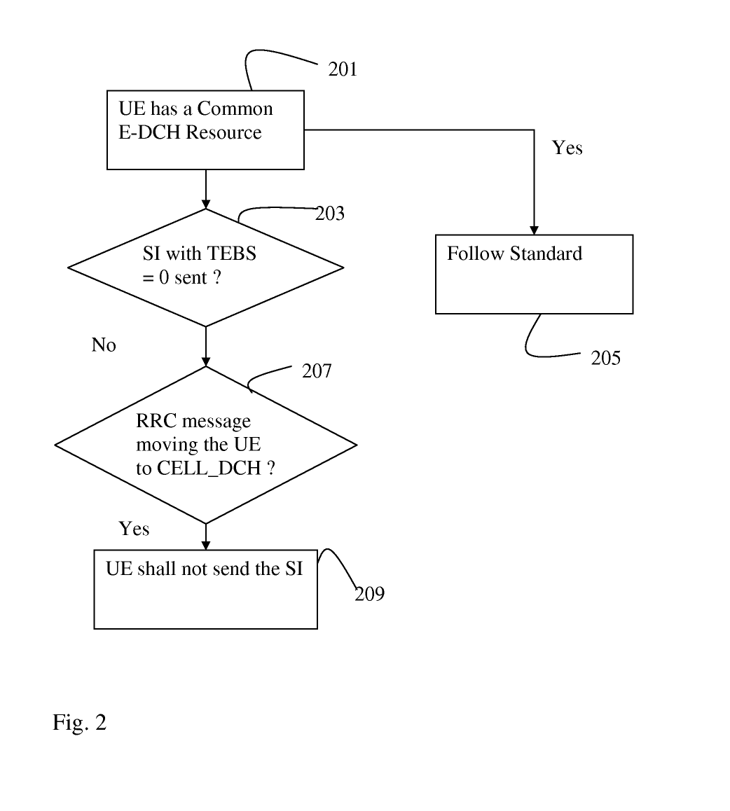

In FIG. 2, an exemplary flowchart illustrating some steps that can be performed in a UE in idle mode is shown. Initially, in a step 201, the UE has a common E-DCH resource. Then, if a SI with TEBS equal to zero is sent in a step 203, the UE is configured to operate in accordance with current standard in a step 205. However, if the UE in idle mode having a common resource and the UE has not sent an SI with TEBS equal to zero and the UE receives an RRC message to move the UE to a CELL_DCH state in a step 207, the UE is configured to not send an SI in a step 209, thereby maintaining the common E-DCH resources. That is the common E-DCH resources are not released as a result of the actions in step 209.

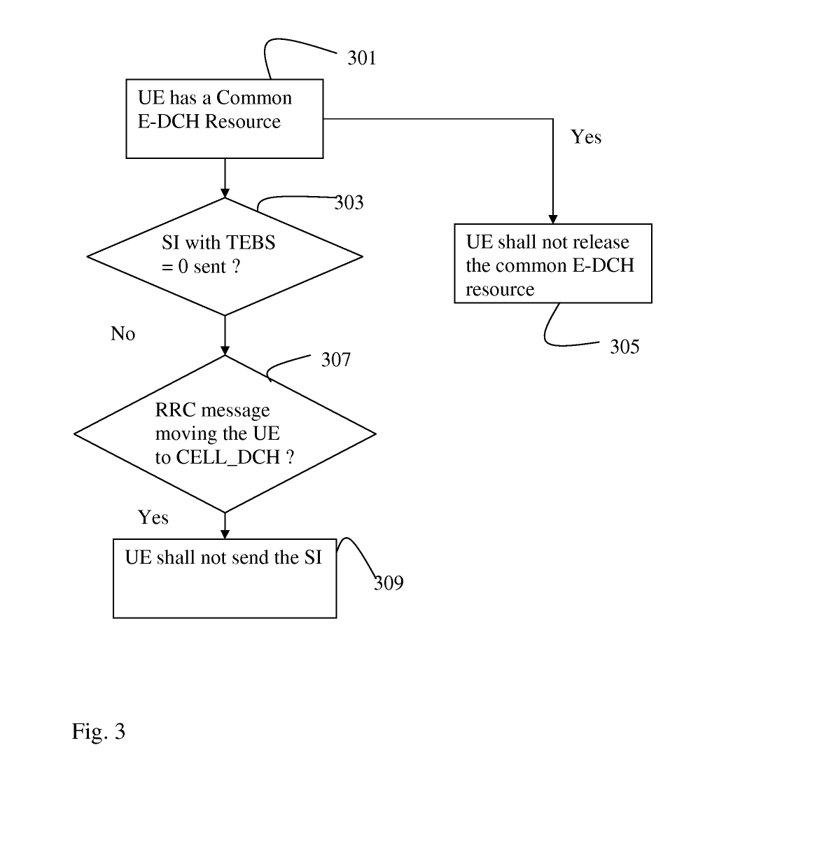

In another embodiment, when the RRC connection setup message is received by the UE and if the UE is allocated a the common E-DCH resource and the SI with TEBS equal to zero has been already sent, then the UE shall not release the common E-DCH resources. In FIG. 3 such a scenario is illustrated. Thus, first in a step 301 the UE in Idle mode has a common E-DCH resource. Then, if a SI with TEBS equal to zero is sent in a step 303, the UE is configured to keep the common E-DCH resource in a step 305. If the UE in idle mode having a common resource and the UE has not sent an SI with TEBS equal to zero and the UE receives an RRC message to move the UE to a CELL_DCH state in a step 307, the UE is configured to not send an SI in a step 309, thereby maintaining the common E-DCH resources. That is the common E-DCH resources are not released as a result of the actions in step 309.

In accordance with some embodiments the UE is configured to not apply the maximum E-DCH resource allocation for CCCH procedure as set out above. Hence, when the configured maximum E-DCH resource allocation for CCCH is reached, the UE is configured to not release the common E-DCH resource.

In some embodiments the UE is configured to consider that upon a reception RRC message, a transition to CELL_DCH from Idle mode has been initiated and that synchronization is already achieved by synchronization procedure AA (as defined in 3GPP TS 25.214) which the UE previously achieved when the common E-DCH resource was assigned. In other words, regardless of whether the UE releases or does not releases the common E-DCH resources, the UE shall consider that the UE is in sync. Thus, the UE is configured to not perform any synchronization procedure upon moving to CELL_DCH state.

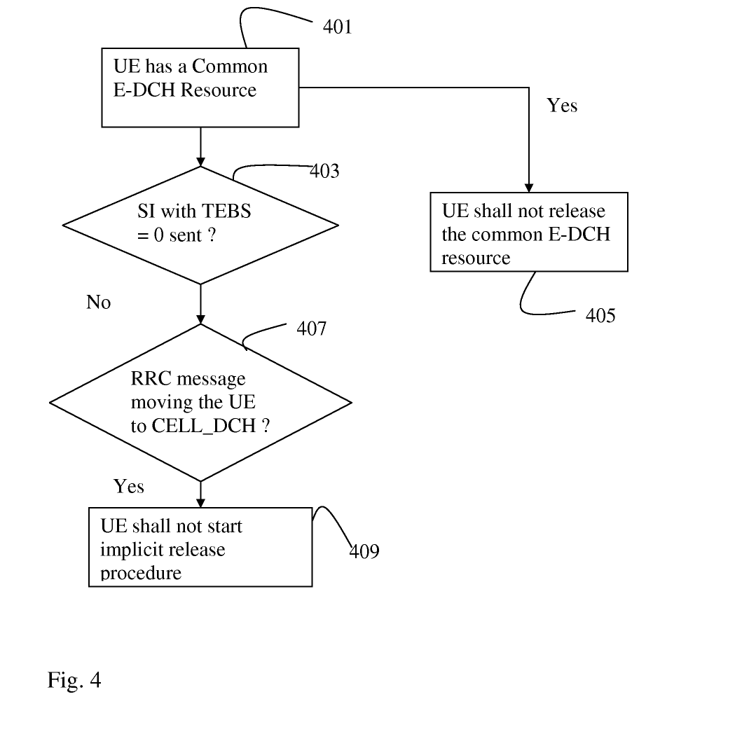

In FIG. 4 a flow chart illustrating some exemplary steps that can be performed are shown. First, in a step 401, a UE in Idle mode has a common E-DCH resource. Then, if a SI with TEBS equal to zero is sent in a step 403, the UE is configured to keep the common E-DCH resource, in a step 405. If the UE in idle mode having a common resource and the UE has not sent an SI with TEBS equal to zero and the UE receives an RRC message to move the UE to a CELL_DCH state, in a step 407, the UE is configured to not start an implicit release procedure in a step 409.

In CELL_FACH state:

The embodiments below can be used one by one or in some cases in combination.

In Cell_FACH state implicit release is enabled if E-DCH transmission continuation back off is not set to infinity.

The implicit release procedure comprises the following steps:

1) When TEBS is 0 byte and the last generated MAC-i PDU with higher layer data is provided with the PHY-data-REQ primitive to the physical layer for transmission.

2) If the “E-DCH transmission continuation back off” value is set to a value larger than “0”:

2.1) Set the timer Tb to “E-DCH transmission continuation back off” value. If TEBS <>0 byte is detected while timer Tb is running, then the timer is stopped and uplink data transmission on the common E-DCH resource continues. If a MAC-ehs PDU is received while timer Tb is running, then the timer is re-started.

3) If the “E-DCH transmission continuation back off” value is set to “0” the MAC-STATUS-Ind primitive indicates to RLC for each logical channel that no PDUs shall be transferred to MAC.

4) If timer Tb expires the MAC-STATUS-Ind primitive indicates to Radio Link Control (RLC) for each logical channel that no PDUs shall be transferred to MAC.

5) TEBS=0 byte is reported by the UE will release to the Node B MAC in the SI in a MAC-i PDU.

5.1) If the “E-DCH transmission continuation back off” value is set to “0”, then the SI shall be transmitted with the MAC-i PDU carrying the last DCCH/DTCH data, given the serving grant is sufficient to carry the SI in the same MAC-i PDU together with the remaining DCCH/DTCH data. Otherwise, the empty buffer status report is transmitted separately with the next MAC-i PDU.

5.2) If the “E-DCH transmission continuation back off” value is set to a value larger than “0”, then the SI is transmitted as a stand-alone message.

6) CMAC-STATUS-Ind which informs the RRC about the Enhanced Uplink in CELL_FACH state and Idle mode process termination is triggered when the empty buffer status has been reported and no MAC-i PDU is left in any HARQ process for (re-)transmission.

7) The UE releases the common E-DCH resources.

In accordance with a first embodiment for controlling E-DCH resources in a UE in CELL-FACH state the following steps are performed. When the RRC RB Setup/RRC RB Reconfiguration message is received by the UE, the UE is configured to not initiate the “implicit release of common E-DCH resources” procedure. This results in that the UE will not perform any of the steps of the implicit release procedure.

In accordance with a second embodiment when the RRC RB Setup/RRC RB Reconfiguration message is received by the UE, the UE shall not perform all the steps of the implicit release procure:

In accordance with the second embodiment some possible options are (Note that multiple options can be used at the same time):

A) In case “E-DCH transmission continuation back off” is set to a value larger than zero (other than “infinity”), the timer Tb shall not be started or if the timer Tb has started, the timer shall be stopped

B) The UE shall not send the SI.

a. Yet, in another embodiment, the UE shall not send the SI with TEBS set to zero.

C) The UE shall not release the common E-DCH resources.

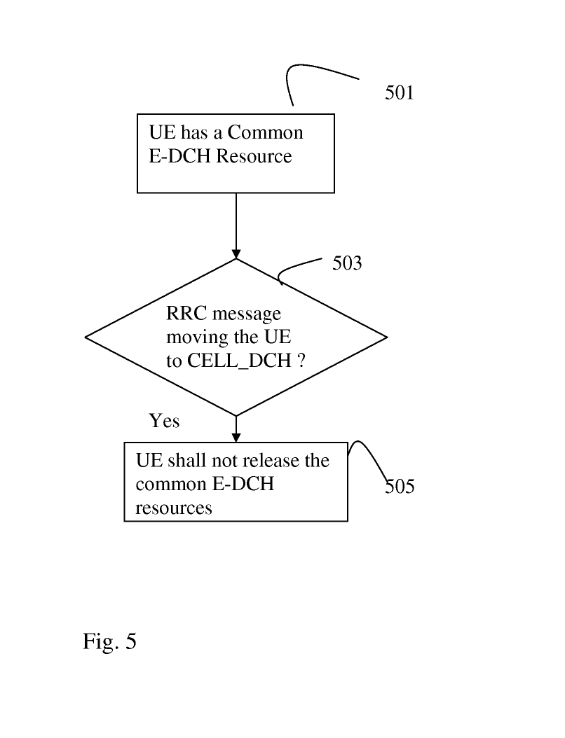

In FIG. 5 a flow chart illustrating some exemplary steps that can be performed in accordance with C) above are shown. First, in a step 501, a UE in CELL_FACH state has a common E-DCH resource. Then, if in a step 503, an RRC message is received that moves the UE to a CELL_DCH state, the UE is configured to keep the common E-DCH resource, in a step 505.

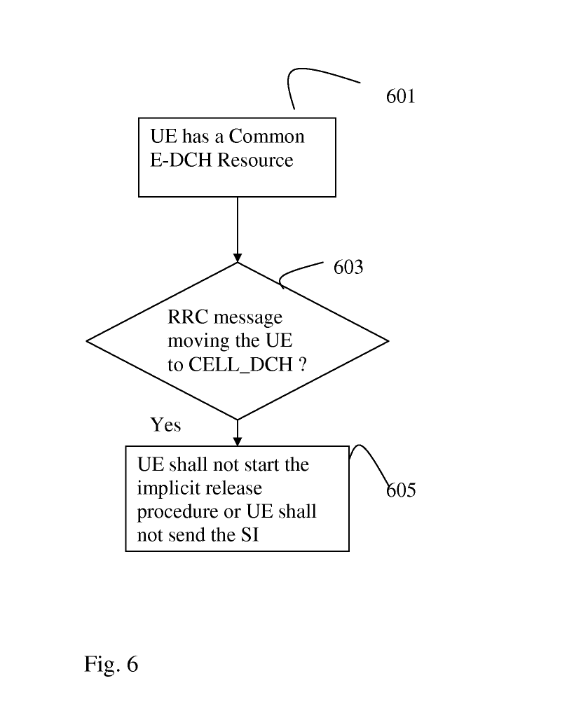

Further, in FIG. 6 some steps performed in accordance with the first embodiment and the second embodiment; option B as set out above, are shown. First, in a step 601 a UE in CELL_FACH state has a common E-DCH resource. Then, if an RRC message is received that moves the UE to a CELL_DCH state in a step 603, the UE is configured to not start an implicit release procedure in a step 605. Also no SI is transmitted by the UE in step 605.

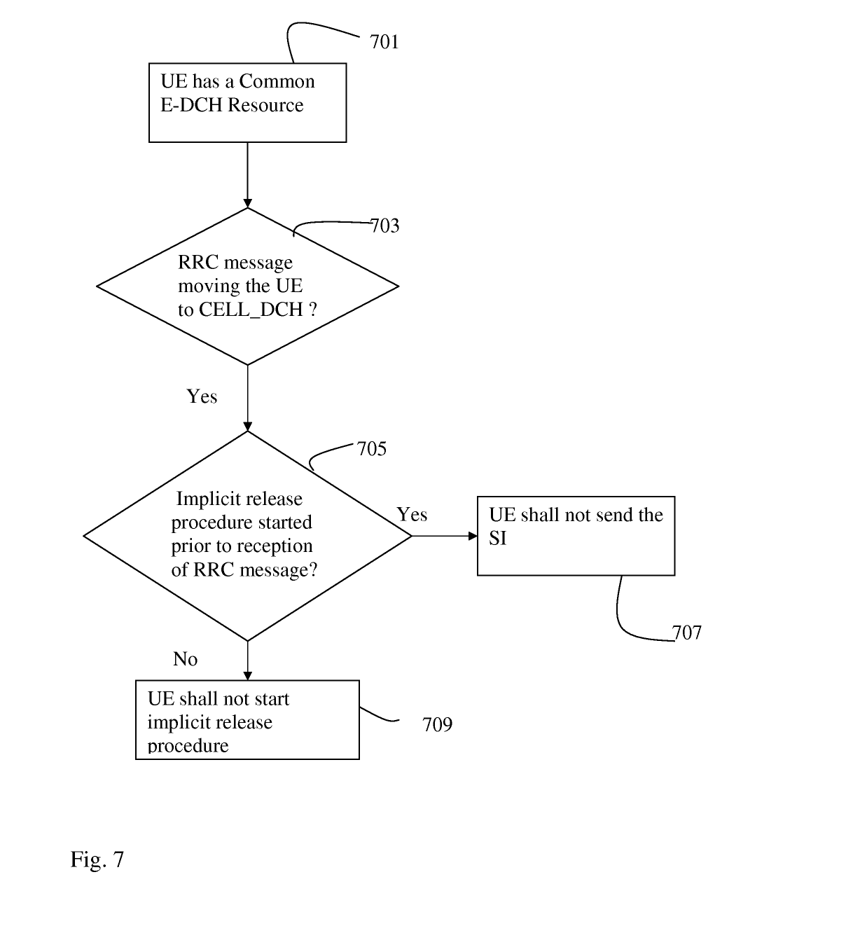

Further, FIG. 7 depicts a flow chart illustrating an optional implementation of a method in accordance with the first embodiment and the second embodiment; option B. First, in a step 701 a UE in CELL_FACH state has a common E-DCH resource. Then, if in a step 703 an RRC message is received that moves the UE to a CELL_DCH state, it is checked in a step 705 if an implicit release procedure has started prior to the reception of the RRC message moving the UE to a CELL_DCH state. If an implicit release procedure has started, the UE will not transmit the SI in step 707. If an implicit release procedure has not started, the UE is configured to not start an implicit release procedure in a step 709.

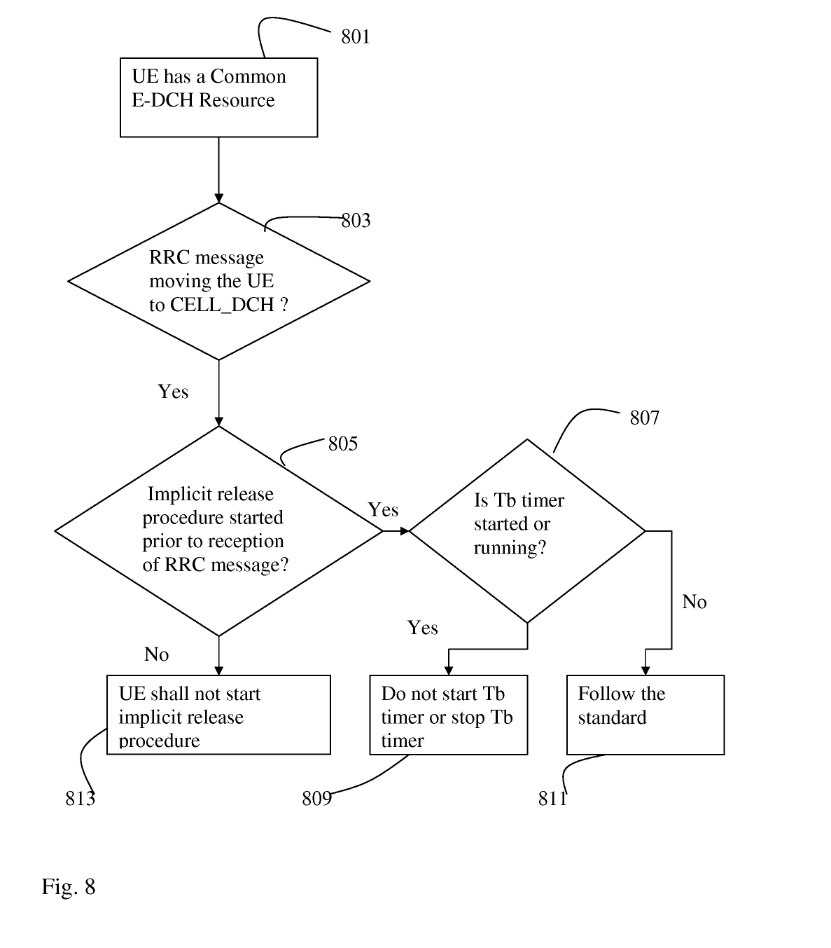

In FIG. 8, a flow chart illustrating an implementation of a method in accordance with the first embodiment and the second embodiment; option A is shown. First, in a step 801, a UE in CELL_FACH state has a common E-DCH resource. Then, in if an RRC message is received that moves the UE to a CELL_DCH state in a step 803, it is checked in a step 805 if an implicit release procedure has started prior to the reception of the RRC message moving the UE to a CELL_DCH state. If an implicit release procedure has started, it is checked in a step 807 if the Tb timer is started or running. If the Tb timer is started or running, do not start the Tb timer or stop the Tb timer if it is running in a step 809; else no special action is taken and the existing standard is followed as set out in step 811. If an implicit release procedure has not started, the UE is configured to not start an implicit release procedure in step 813.

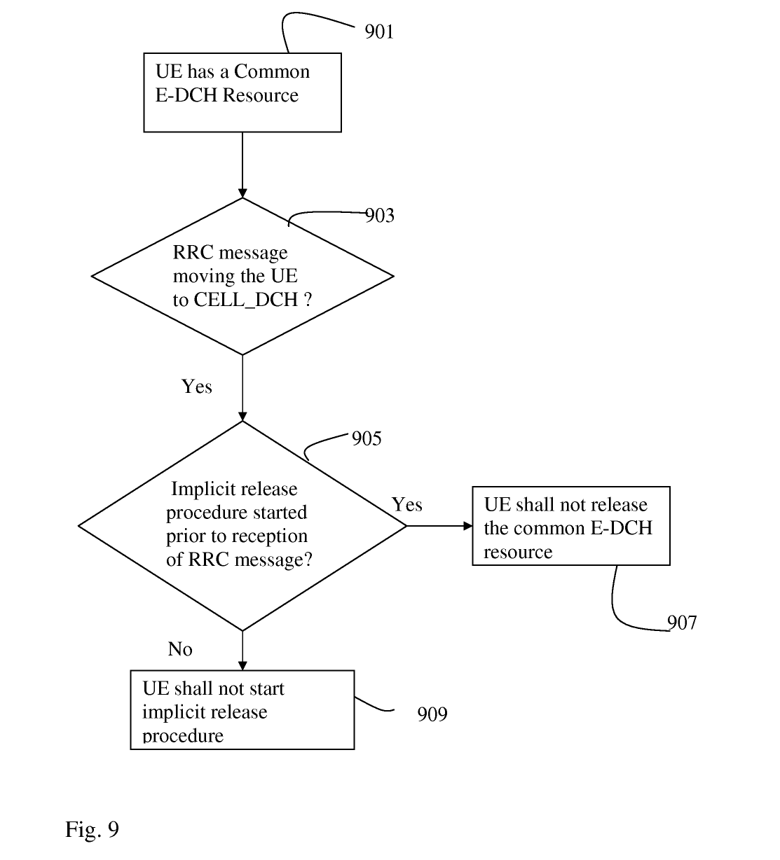

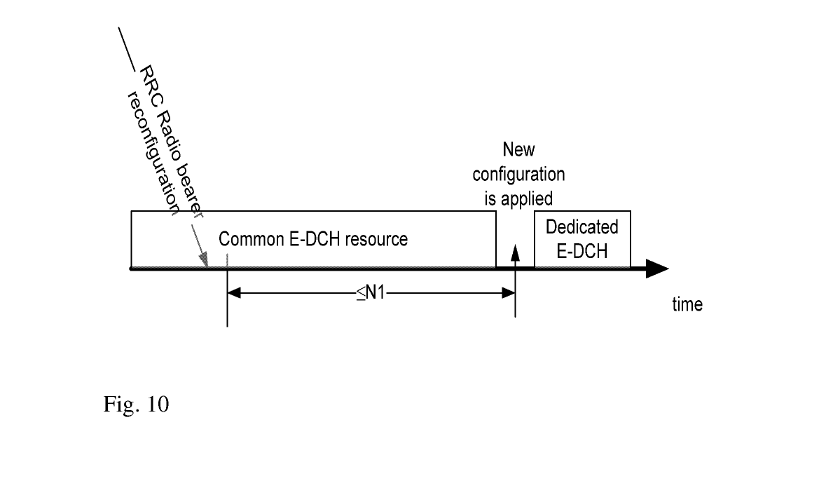

In FIG. 9, a flow chart illustrating an optional implementation of a method in accordance with the first embodiment and the second embodiment; option C is shown. First, in a step 901, a UE in CELL_FACH state has a common E-DCH resource. Then, if an RRC message is received that moves the UE to a CELL_DCH state in a step 903, it is checked if an implicit release procedure has started prior to the reception of the RRC message moving the UE to a CELL_DCH state in a step 905. If an implicit release procedure has started, the UE is configured to not release the common E-DCH resource in a step 907. If an implicit release procedure has not started, the UE is configured to not start an implicit release procedure in a step 909.

In accordance with a third embodiment the UE can be configured to consider that upon the reception of a RB Setup or RB configuration message, a transition to CELL_DCH from CELL_FACH state has been initiated and that synchronization is already achieved by synchronization procedure AA (as defined in 3GPP TS 25.214), which the UE previously achieved when the common E-DCH resource was assigned. In other words, regardless of whether the UE releases or does not releases the common E-DCH resources, the UE shall consider that the UE is synchronized. Thus, the UE would not perform any synchronization procedure upon moving to CELL_DCH state. This can be added in existing standards 3GPP standards TS 25.321, Medium Access Control (MAC) protocol specification and 3GPP TS 25.322, Radio Link Control (RLC) protocol specification.

In a fourth embodiment if the UE has already sent the SI with TEBS equal to zero when the RB setup or RB reconfiguration messages is received, the UE is configured to proceed with the release of the common E-DCH resources when all HARQ processes are finished but the UE shall store the timing and synchronization information of the common E-DCH resource. When the new configuration is applied, the UE is configured to not perform a synchronization procedure A, as defined in 3GPP TS 25.214, and utilizes the stored information to achieved synchronization in the new dedicated E-DCH resource.

In a fifth embodiment if the UE has already sent the SI with TEBS equal to zero when the RB setup or RB reconfiguration messages is received, the UE is configured to UE proceed with the release of the common E-DCH resources when all HARQ processes are finished and the UE maintains downlink chip and frame synchronization of Dedicated Physical Control Channel (DPCCH) or Fractional Dedicated Physical Channel (F-DPCH) corresponding to the activated uplink frequency, using the Primary Common Control Physical Channel (P-CCPCH) timing and timing offset information notified from UMTS Terrestrial Radio Access Network (UTRAN) until the new configuration is applied.

Use of the methods and devices in accordance with embodiments described herein can remove the need for UE to perform the synchronization procedure A when moving from Idle mode to CELL_DCH and from CELL_FACH state to CELL_DCH state thereby avoiding a data interruption time of several hundreds of milliseconds.

1-12. (canceled)

13. A method in a User Equipment (UE), the UE having a common Enhanced Dedicated Channel (E-DCH) resource, the method comprising the steps of:
receiving a pre-defined message, said message moving the UE from a source state to a target state, where the target state is a CELL_DCH state with E-DCH configured; and
upon reception of said pre-defined message, configuring the UE to hold on to the common E-DCH resource.

14. The method of claim 13, wherein the pre-defined message is a Radio Resource Control (RRC) Radio Bearer (RB) Reconfiguration message.

15. The method of claim 13, wherein the pre-defined message is an RRC RB Setup message.

16. The method of claim 13, wherein the pre-defined message is an RRC Connection setup.

17. The method of claim 13, wherein the UE when receiving said pre-defined message is in idle mode.

18. The method of claim 13, wherein the UE when receiving said pre-defined message is in CELL_FACH state in connected mode.

19. A User Equipment (UE), the UE being configurable to have a common Enhanced Dedicated Channel (E-DCH) resource, the UE further being configured to receive a pre-defined message and to move the UE from a source state to a target state upon reception of the pre-defined message, where the target state is a CELL_DCH state with E-DCH configured, and the UE being configured to hold on to the common E-DCH resource upon reception of said pre-defined message.

20. The User Equipment of claim 19, wherein the pre-defined message is an RRC Radio Bearer (RB) Reconfiguration message.

21. The User Equipment of claim 19, wherein the pre-defined message is an RRC RB Setup message.

22. The User Equipment of claim 19, wherein the pre-defined message is an RRC Connection setup.

23. The User Equipment of claim 19, wherein the UE is configured to receive said pre-defined message when the UE is in idle mode.

24. The User Equipment of claim 19, wherein the UE is configured to receive said pre-defined message when the UE is in CELL_FACH state in connected mode.
